(19) United States
(12) Patent Application Publication
(10) Pub. No.: US 2013/0325330 A1
(43) Pub. Date: Dec. 5, 2013

(54) Method of establishing Map Data and Navigation Device

(71) Applicant: Kuo-Yi Chen, New Taipei City (TW)

(72) Inventor: Kuo-Yi Chen, New Taipei City (TW)

(21) Appl. No.: 13/594,882

(22) Filed: Aug. 27, 2012

(30) Foreign Application Priority Data
May 31, 2012 (TW) 101119507

(51) Int. Cl. G01C 21/32

(52) U.S. Cl. 701/450

(57) ABSTRACT

A method of establishing map data for a navigation device is disclosed. The navigation device includes a position device for receiving satellite signals to obtain coordinates of the navigation device, a user interface for receiving a command, a map database for storing map data, and a navigation processor coupled to the user interface, the position device and the map database for outputting a comparison result according to the command, the coordinates and the map data. The method includes recording the plurality of coordinates of the position device, comparing the plurality of coordinates with the map data to generate the comparison result, and determining whether to update or establish new map data according to the command.

### BACKGROUND OF THE INVENTION

1. Field of the Invention

The invention relates to a method of establishing map data and a navigation device, and more particularly, to a method of establishing map data and a navigation device according to coordinates decoded from satellite signals.

2. Description of the Prior Art

Personal Navigation Devices (hereinafter called PNDs) are widely used to provide geolocation, maps, path planning, turn-by-turn directions, and, in some newer models, real-time traffic and weather updates, such that a user may arrive a destination efficiently and save time in finding directions.

A map provider normally establishes or updates the map data by a field survey and stores new map data in a licensed server or database, such that the users may download the new map data to their PNDs from the Internet or storages such as memory and disk, or add a new attraction or location manually. However, such an update method is inconvenient for the users, because the users need to learn an update procedure and update the map data frequently. Besides, traffic and transport construction changes so fast that the map database may not catch up with the real traffic and transport construction. As a result, sometimes it may happen that the user goes to some road not existing in the map data, which causes the PND to lose its navigation function.

Furthermore, the PND decodes satellite signals received per second from satellites to obtain current longitude and latitude coordinates of itself and utilizes an algorithmic program to transfer the longitude and latitude coordinates to coordinates corresponding to the map data, so the PND may provide turn-by-turn directions to the user accordingly. Nevertheless, there may be coordinate errors between the coordinates corresponding to the map data and the longitude and latitude coordinates measured by the satellites, and the algorithmic program may have errors too. For example, the PND notifies of an arrival of the destination, but in fact the user does not arrive at the destination. Thus, the user may be confused in finding the real destination due to the coordinate errors or the algorithmic errors.

Therefore, there is a need to improve the prior art to provide more convenient methods of updating the map data to the user, and improve the coordinate errors and the algorithmic errors.

### SUMMARY OF THE INVENTION

It is therefore an object of the invention to provide a method of establishing map data and a navigation device according to coordinates decoded from satellite signals.

An embodiment of the invention discloses a method of establishing map data for a navigation device, the navigation device comprises a position device for receiving a plurality of satellite signals to obtain a plurality of coordinates of the navigation device, a user interface for receiving a command inputted by a user, a map database for storing map data, and a navigation processor coupled to the user interface, the position device and the map database for outputting a comparison result according to the command, the coordinates and the map data. The method comprises recording the plurality of coordinates of the position device, comparing the plurality of coordinates with the map data to generate the comparison result, and determining whether to update or establish new map data according to the command.

The invention further discloses a navigation device comprising a position device for receiving a plurality of satellite signals to obtain a plurality of coordinates of the navigation device, a user interface for receiving a command inputted by a user, a map database for storing map data, and a navigation processor coupled to the user interface, the position device and the map database for outputting a comparison result according to the command, the coordinates and the map data, such that the user determines whether to update or establish a new map data in the map database accordingly.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a navigation device according to an embodiment of the invention.

FIG. 2 is a schematic diagram of the navigation processor shown in FIG. 1 according to an embodiment of the invention.

FIG. 3 is a schematic diagram of a map data update process according to an embodiment of the invention.

### DETAILED DESCRIPTION

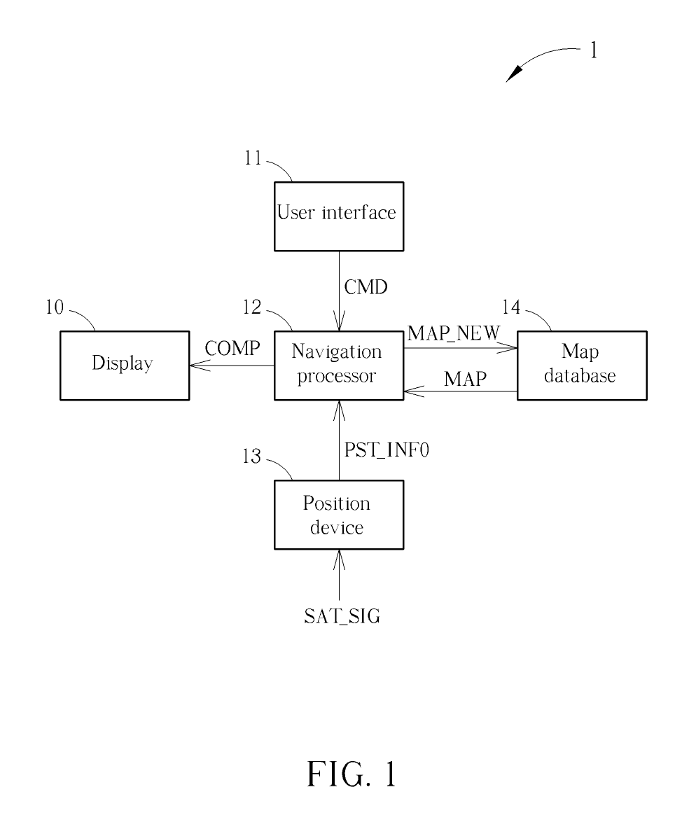

Please refer to FIG. 1, which is a schematic diagram of a navigation device according to an embodiment of the invention. The navigation device 1 comprises a display 10, an user interface 11, a navigation processor 12, a position device 13 and a map database 14. The user interface 11 is used for receiving a command CMD inputted by an user to control an operation of the navigation processor 12. The position device 13 may be a Global Position System device or a receiver of another position system for receiving satellite signals SAT_SIG to obtain coordinates PST_INFO. The map database 14 is used for storing map data MAP. The navigation processor 12 is coupled to the display 10, the user interface 11, the position device 13 and the map database 14 for outputting a comparison result COMP to the display 10 according to the command CMD, the coordinates PST_INFO and the map data MAP, such that the user may determine whether to update or establish map data MAP_NEW into the map database 14 accordingly. The display 10 is used for displaying the comparison result COMP.

In operation, the navigation processor 12 may compare the coordinates PST_INFO with the map data MAP. If the coordinates PST_INFO do not exist in the map database 14, or there is a specific difference between the coordinates PST_INFO and map data MAP, the navigation processor 12 may output the comparison result COMP to the display 10, such that the display 10 may display or pop-up a query window (not shown in FIG. 1) to query the user whether to update or establish the new map data MAP_NEW. The user may input the command CMD to control the navigation processor 12 to (or not to) update or establish the new map data MAP_NEW. The coordinates PST_INFO may be a specific coordinate of an attraction or a road/path comprising many coordinates, and the navigation processor 12 may update the attraction/road/path into the map database 14 to correct coordinate errors in the map data MAP or establish a new attraction/road/path. For example, when the user arrives a destination and stops a navigation function of the navigation device 1, and the navigation processor 12 found there is a difference between the coordinate of the current destination and the coordinate in the map data MAP, the navigation device 1 may query the user whether to update the coordinate of the current destination. Or, the navigation device 1 may query the user whether to update or establish a new path when the navigation processor 12 finds a new path to the current destination.

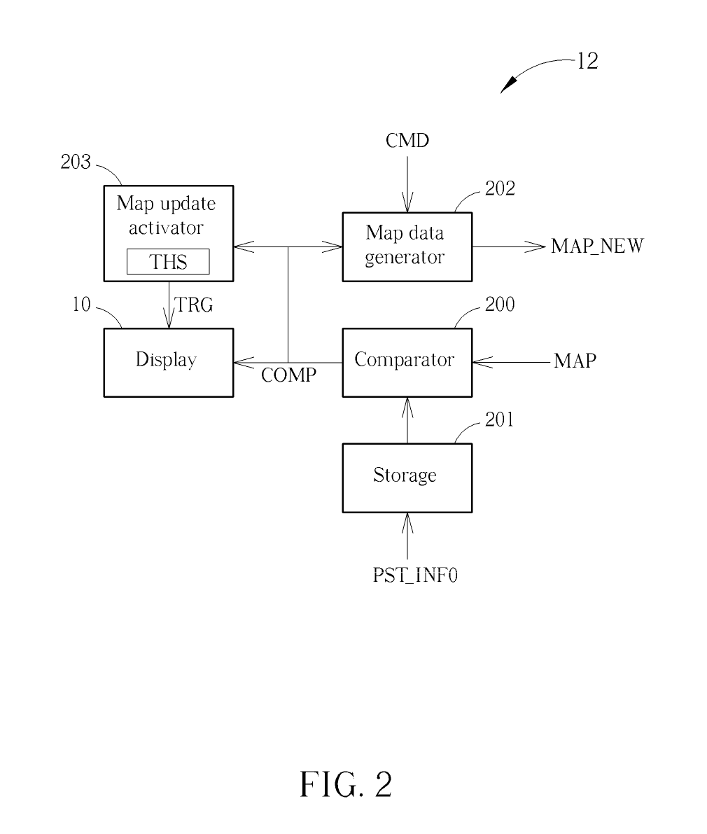

Please refer to FIG. 2, which is a schematic diagram of the navigation processor 12 according to an embodiment of the invention. The navigation processor 12 comprises a comparator 200, a storage 201 and a map data generator 202. The storage 201 is coupled to the position device 13 for receiving and recording the coordinates PST_INFO. The comparator 200 is coupled to the storage 201, the display 10 and the map database 14 for comparing the coordinates PST_INFO with the map data MAP to generate the comparison result COMP to the display 10. The map data generator 202 is coupled to the comparator 200 and the map database 14 for generating the new map data MAP_NEW according to the comparison result COMP and the command CMD inputted by the user. For example, if the command CMD is yes, the map data generator 202 may generate the new map data MAP_NEW to output to the map database 14 according to the comparison result COMP. If the command CMD is no, the map data generator 202 does not generate the new map data MAP_NEW. Specifically, the navigation device 1 may display the complete path from the start point to the destination, and display the comparison result COMP or a path that does not exist in the map database 14 by different colors. For example, the path having the coordinate errors within 10 meters and the path having the coordinate errors over 10 meters (or does not exist) are shown by different colors, and the user may select any section of the path, so that the map data generator 202 may generate the corresponded map data MAP_NEW. If the coordinate errors are within 10 meters, the user may input the command CMD to control the map data generator 202 to generate the map data MAP_NEW and update the map database 14. If the coordinate errors are greater than 10 meters, which means the coordinates corresponding to the coordinate errors may not exist, the user may input the command CMD to control the map data generator 202 establish the new map data MAP_NEW and update the map database 14.

In short, the invention may compare the coordinates PST_INFO decoded from the satellite signal SAT_SIG with the map data MAP stored in the map database 14 to update or establish the new map data MAP_NEW. Therefore, the navigation processor 12 may not required to execute an algorithmic program for mapping the coordinates PST_INFO to the map data MAP, which may avoid errors in the algorithm program. Also, the new map data MAP_NEW is established according to longitude, latitude and altitude coordinates decoded from the satellite signals SAT_SIG, which may provide a high precision of the map data MAP.

The navigation processor 12 may further comprise a map update activator 203 to avoid error misjudges or unnecessary establishments of the map data MAP. The map update activator 203 is coupled to the comparator 200 and the display 10 for outputting an activate signal TRG to the display 10 according to the comparison result COMP and a threshold value TSH stored in the map update activator 203 to control the display 10 to display the comparison result COMP and the query window to the user. The threshold value TSH may be a coordinate error range or a number of coordinate errors corresponding to the same coordinate. For example, if the comparison result COMP indicates the coordinate errors of the coordinates PST_INFO are less than 5 meters, i.e. the threshold value TSH, the map update activator 203 may output the activate signal TRG to limit displaying the comparison result COMP and deactivate the map data establishment. Or, the map update activator 203 may record the number of the coordinate errors corresponding to the same coordinates to determine whether to activate the map data establishment. For example, if the user follows the same path over 10 times, i.e. the threshold value TSH, and the coordinate errors of the same path are almost the same, the map update activator 203 may output the activate signal TRG to output the comparison result COMP and query the user whether to update or establish the new map data MAP_NEW. As a result, the map update activator 203 may avoid the error misjudges or the unnecessary establishments of the map data MAP, which may improve an applicability of the map data establishment in practice.

Furthermore, the command signal CMD may correspond to a usage mode, a type of a road or a path resolution to establish the map data MAP_NEW. For example, the user may take different vehicles or walk to the destination, and the usage mode may be a vehicle navigation mode, a bicycle navigation mode, a walk navigation mode, a hike navigation mode and so on. In general, there are types of the road designed for different vehicles or pedestrians in the traffic and transport construction. The type of the road may be a sidewalk, a two-way road, a one-way road, a driveway, a bridge, a tunnel, a freeway and so on, one of which may be selected by the user to establish the new map data MAP_NEW. For example, if the user uses the vehicle navigation mode, the user may pass a driveway, a freeway or general roads instead of a sidewalk, and the user may select one of the roads to establish into the map database 14. Moreover, the usage mode and the corresponded vehicle may respond to a move speed and a path resolution. If the user is driving on the freeway with a high speed, a coordinate variation of the satellite signals SAT_SIG received per second by the navigation device 1 may be a great value, so that the path resolution is small, which may save a memory space for storing the path in the map database 14. In another case, if the user uses the hike navigation mode, a walk speed of the user is relative low, and the coordinate variation of the satellite signals SAT_SIG received per second by the navigation device 1 may be a small value, so that the path resolution is great, which may provide precise directions and safety for the user since a hiking trail may be narrow and dangerous. Therefore, the invention may establish the map data MAP_NEW corresponding to the usage mode, the type of the road or the path resolution to suit for the practical applicability.

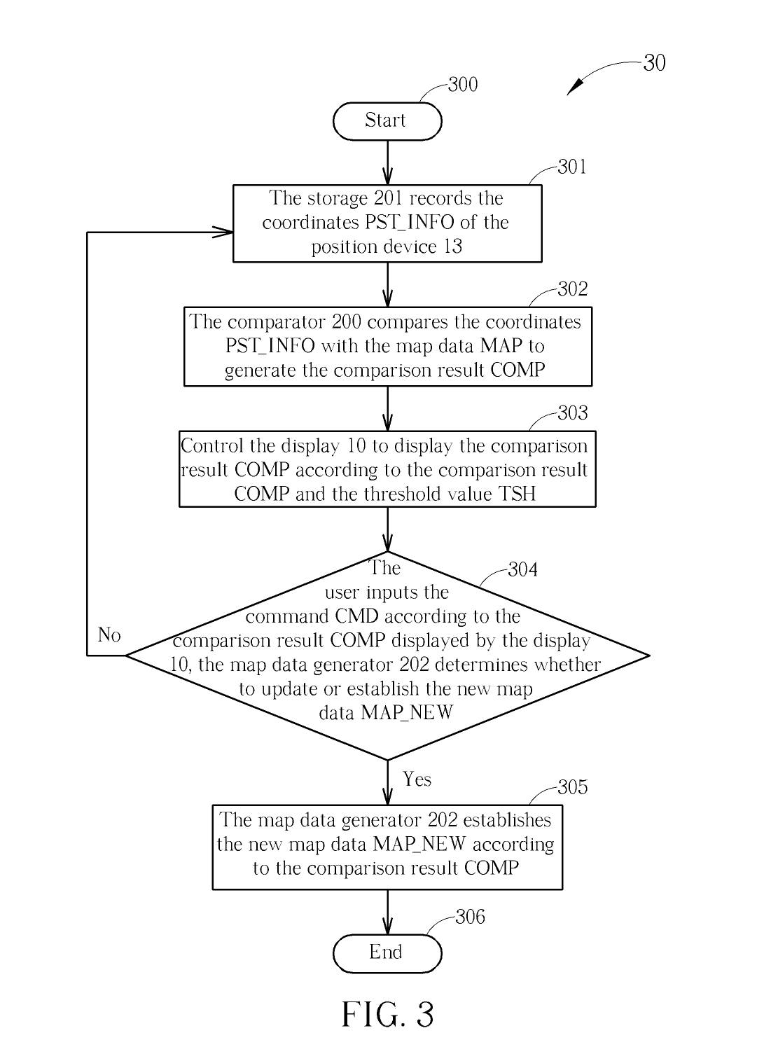

Operations of the navigation processor 12 may be summarized into a map data establish process 30. As shown in FIG. 3, the map data update process 30 includes the following steps.

Step 300: Start.

Step 301: The storage 201 records the coordinates PST_INFO of the position device 13.

Step 302: The comparator 200 compares the coordinates PST_INFO with the map data MAP to generate the comparison result COMP.

Step 303: Control the display 10 to display the comparison result COMP according to the comparison result COMP and the threshold value TSH.

Step 304: The user inputs the command CMD according to the comparison result COMP displayed by the display 10, the map data generator 202 determines whether to update or establish the new map data MAP_NEW. If yes, go to Step 305; if no, go to Step 301.

Step 305: The map data generator 202 establishes the new map data MAP_NEW according to the comparison result COMP.

Step 306: End.

In practice, the satellite signals SAT_SIG received by the position device 13 conforms to 0183-NMEA sentences established by National Marine Electronic Association. The following sentences are examples of the satellite signals SAT_SIG:

### $GPGGA,170834,4124.8963,N,08151.6838,W,1,05,1.5,280.2,M,−34.0,M,,,*59

### $GPRMC,010745.84,A,2503.6239,N,12138.8513,E,,,091106,,W,A*01

### $GPGSV,3,1,12,1,77,168,46,3,32,195,42,6,20,46,40,7,63,98,45*7D

### $GPGSV,3,2,12,14,28,150,41,16,62,296,45,19,6,200,40,20,17,278,39*41

### $GPGSV,3,3,12,21,4,103,,23,18,321,41,25,57,31,46,31,52,43,44*45

The following Table describes example data of the first satellite signal SAT_SIG and corresponded description in the 0183-NMEA sentence:

| Name | Example Data | Description |
|---|---|---|
| Sentence Identifier | $GPGGA | GPS Fix Data |
| Time | 170834 | 17:08:34 Universal Time, |
| | | Coordinated |
| Latitude | 4124.8963, N | 41d 24.8963′ N or 41d 24′ 54″ N |
| Longitude | 08151.6838, W | 81d 51.6838′ W or 81d 51′ 41″ W |
| Fix Quality: | 1 | Data is from a GPS fix |
| 0 = Invalid | | |
| 1 = GPS fix | | |
| 2 = DGPS fix | | |
| Number of Satellites | 05 | 5 satellites are in view |
| Horizontal Dilution | 1.5 | Relative accuracy of |
| of Precision | | horizontal position |
| Altitude | 280.2, M | 280.2 meters above mean sea |
| | | level |
| Height of geoid | −34.0, M | −34.0 meters |
| above WGS84 | | |
| ellipsoid | | |
| Time since last | blank | No last update |
| Differential-GPS | | |
| update | | |
| D-GPS reference | blank | No station ID |
| station ID | | |
| Checksum | *59 | Used by program to check for |
| | | transmission errors |

According to the Table, the coordinates PST_INFO at least comprise longitude, latitude and altitude coordinates, and thus the invention may establish the three-dimension map data MAP_NEW. Thus, flat roads, viaducts, underground tunnel or hilly roads, whose longitude, latitude and altitude coordinates may be stored in the map database 14 to build the precise map data MAP_NEW. In comparison, the traditional map data only comprise the two-dimension longitude and latitude coordinates and except the altitude coordinates. When the user drives on the viaduct overlapped with the flat road, the two-dimension map data may not indicate the current location is at the viaduct or the flat road, which causes the user to be confused to find the right way. In other words, the three-dimension map data MAP_NEW is established by the coordinates PST_INFO decoded from the satellite signals SAT_SIG to have latitude, longitude and altitude coordinates, which provides precise coordinates in the map database 14 and clear location indications on overlapped ways.

To sum up, the traditional method of updating map data is inconvenient for the user because the user needs to learn the update procedure and update the map data frequently to keep up with the fast-changed traffic construction. Besides, there may be coordinate errors and algorithmic errors between the coordinates corresponding to the map data and the coordinates measured by the satellites, which may cause the PND to fail to provide the correct navigation. In comparison, the invention may compare the coordinates PST_INFO decoded from the satellite signal SAT_SIG with the map data MAP stored in the map database 14 to update or establish the new map data MAP_NEW. Therefore, the navigation processor 12 may not be required to execute the algorithm program for mapping the coordinates PST_INFO to the map data MAP, which may avoid algorithmic errors of the algorithm program. Also, the new map data MAP_NEW is established according to longitude, latitude and altitude coordinates decoded from the satellite signals SAT_SIG, which may provide a high precision of the map data MAP and saves human resources on field survey to establish the map data as well.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of establishing map data for a navigation device, the navigation device comprising a position device for receiving a plurality of satellite signals to obtain a plurality of coordinates of the navigation device, a user interface for receiving a command inputted by a user, a map database for storing map data, and a navigation processor coupled to the user interface, the position device and the map database for outputting a comparison result according to the command, the coordinates and the map data, the method comprising:
recording the plurality of coordinates of the position device;
comparing the plurality of coordinates with the map data to generate the comparison result; and
determining whether to update or establish new map data according to the command.

2. The method of establishing map data of claim 1, wherein the step of determining whether to update or establish new map data according to the command further comprises:
outputting an activate signal according to the comparison result and a threshold value to update or establish the new map data.

3. The method of establishing map data of claim 2, wherein the threshold value is a coordinate error range or a number of coordinate errors corresponding to a same coordinate.

4. The method of establishing map data of claim 1, wherein the map data and the coordinate comprise at least a longitude, a latitude and an altitude of the navigation device.

5. The method of establishing map data of claim 1, wherein the satellite signals conform to a 0183-NMEA code.

6. The method of establishing map data of claim 1, wherein the command signal corresponds to a usage mode, a type of road or a path resolution.

7. A navigation device comprising:
a position device for receiving a plurality of satellite signals to obtain a plurality of coordinates of the navigation device;
a user interface for receiving a command inputted by a user;
a map database for storing map data; and
a navigation processor coupled to the user interface, the position device and the map database for outputting a comparison result according to the command, the coordinates and the map data, such that the user determines whether to update or establish a new map data in the map database accordingly.

8. The navigation device of claim 7, wherein the navigation processor comprises:
a storage coupled to the position device for receiving and storing the plurality of coordinates;
a comparator coupled to the storage and the map database for comparing the plurality of coordinates with the map data to generate the comparison result; and
a map data generator coupled to the comparator and the map database for generating new map data into the map database according to the comparison result and the command inputted by the user.

9. The navigation device of claim 8, wherein the navigation processor comprises a map update activator coupled to the comparator for outputting an activate signal to determine whether to update or establish the new map data according to the comparison result and a threshold value.

10. The navigation device of claim 9, wherein the threshold value is a coordinate error range or a number of coordinate errors corresponding to a same coordinate.

11. The navigation device of claim 7, wherein the command signal corresponds to a usage mode, a type of road or a path resolution.

12. The navigation device of claim 7, wherein the satellite signals conform to a 0183-NMEA code.

13. The navigation device of claim 7, wherein the map data and the coordinate comprise at least a longitude, a latitude and an altitude of the navigation device.

14. The navigation device of claim 7, further comprising a display coupled to the navigation processor for displaying the comparison result.
